(19) United States
(12) Patent Application Publication
(10) Pub. No.: US 2016/0096574 A1
(43) Pub. Date: Apr. 7, 2016

(54) Tiltable Motor Tricycle

(71) Applicant: Yong-Biao Liu, Salinas, CA (US)

(72) Inventor: Yong-Biao Liu, Salinas, CA (US)

(21) Appl. No.: 14/503,399

(22) Filed: Oct. 1, 2014

(51) Int. Cl. B62K 5/10; B62K 5/027

(52) U.S. Cl. CPC B62K 5/10; B62K 5/027

(57) ABSTRACT

A tiltable motor tricycle as in the present invention comprises a front part and a rear part. The front part comprises a front frame, a front fork, a front wheel attached to the front fork, a steering bar, and a seat. The rear part comprises a rear frame, one pair of laterally spaced rear wheels. The front frame is connected to the rear frame rotatably around an axis line which points at the ground contact area of the front wheel and therefore the front part can tilt right or left around the axis line without affecting the position of the rear part. The rear frame has two footrests at two sides of the tricycle. The tricycle further comprises a motor and a power source. When in operation, the rider of the tricycle seats on the seat with two feet stepping on the footrests of the rear frame to keep balance and can tilt the front part of the tricycle around the axis line to maintain balance in response to road condition, speed, or turning while the rear part with two rear wheels remain stable. The motor can be an electric motor integrated into the hub of the front wheel or mounted to the rear frame to drive the rear wheels and the power source is a battery. It can also be any other types of motors and the power source is a type of liquid or gaseous fuel suitable for the type of the motor.

### BACKGROUND OF THE INVENTION

1. Field of the Invention

The present invention relates to a personal transportation device; and more particularly the present invention relates to motorcycle, electric bike, and tricycle for personal transportation.

2. Description of the Related Art

To be able to tilt in response to road conditions or changes of moving directions is important to maintain balance and therefore safety in riding tricycles. There are several prior arts disclosing a variety of mechanisms to make tricycles tiltable including U.S. Pat. Nos. 8,292,315, 7,887,070, 7,762,368, 5,240,267, 4,678,053, 4,634,137, 4,453,616, and 4,279,429, and U.S. Pat. Application US2009/0289437. All these prior arts differ significantly from the present invention in a variety of ways. In these specific inventions, elaborate mechanisms are used to achieve tilting of the tricycles. Therefore, a simple mechanism of achieving the tilting will be desirable for widespread of adaptation of tricycles as a common personal transportation tool.

### SUMMARY OF THE INVENTION

The primary objective of the current invention is to provide a tiltable motor tricycle with a simple mechanism to tilt to adjust gravity center for maintaining balance and to provide a safe personal transportation tool. It is another objective of the present invention to provide a personal transportation tool which is compact, has a low production cost, and suitable to meet the normal commuting and other travel needs.

To achieve these objectives, the tiltable motor tricycle as in the present invention comprises a front part and a rear part. The front part comprises a front frame, a front fork, a front wheel attached to the front fork, a steering bar, and a seat. The rear part comprises a rear frame, one pair of laterally spaced rear wheels. The front frame is connected to the rear frame rotatably around an axis line which points at the ground contact area of the front wheel and therefore the front part can tilt right or left around the axis line while the rear part remains stable. The rear frame has two footrests at the left and right sides of the tricycle. The tricycle further comprises a motor and a power source. When in operation, the rider of the tricycle rests on the seat with two feet stepping on the footrests of the rear frame, and can adjust his/her gravity center by tilting the front part and using two feet on the rear part to provide support.

The present invention can have several preferred embodiments. For example, the motor and the power source can have different locations and types. The motor can be an electric hub motor on the front wheel or on a common axle of the two rear wheel. It can also be a motor of any other types. The power source can be a battery or others depending on type of the motor and can be positioned on the rear frame or the front frame. The tricycle may also comprise a throttle on the steering bar to accelerate and regulate speed. In the embodiment of an electric tricycle, the tricycle also comprises a controller which is connected to the battery and the throttle to achieve the control of the electric motor.

The present invention has advantages of being simple in mechanism and structure, and therefore being easy to manufacture at a low cost. Motorcycles and electric bikes have become popular transportation tools because they are environmental friendly, cost less than cars to own and operate. However, they carry high risks of traffic accident as they are prone to fall when tires loose traction with ground. The tiltable motor tricycle as in the present invention provides a safer alternative to two wheeled vehicles and a more affordable and easy to use alternative to other types of tricycles.

Furthermore, the described features and specifications may be combined in any suitable manner in one or more embodiments. One skilled in the relevant art will recognize that the invention can be practiced without one or more of the specific features or advantages of a particular embodiment.

### BRIEF DESCRIPTION OF THE DRAWINGS

FIG. 1 is a perspective view of a first preferred embodiment of the present invention;

FIG. 2 is a rear-top prospective view of the rear part and the connection between the front frame and the rear frame of the first preferred embodiment of the present invention;

FIG. 3 is a perspective view of a second preferred embodiment of the present invention;

FIG. 4 is a side view of the second preferred embodiment of the present invention showing a vertical cross section along the longitudinal axis of the rear part.

### DETAILED DESCRIPTION

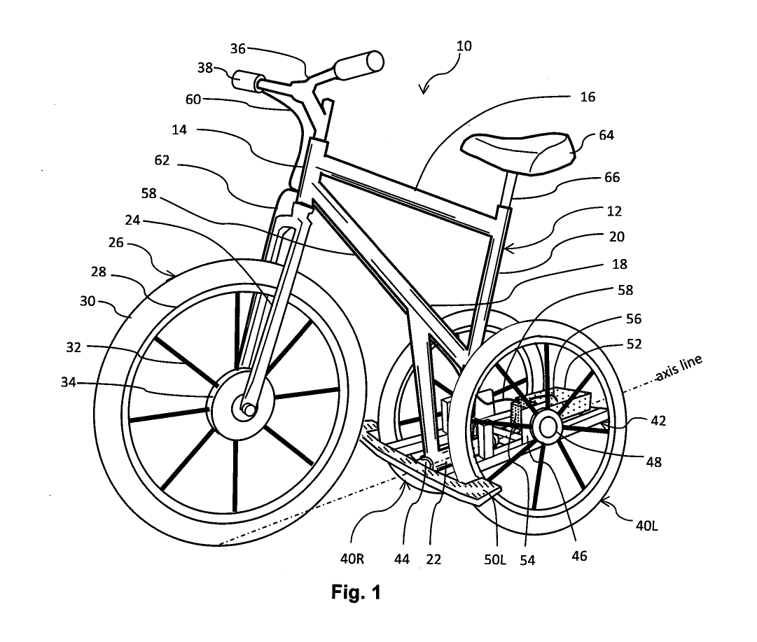

With reference to FIG. 1 for the first preferred embodiment 10, the tiltable motor tricycle of the current invention comprises a front frame 12, a front fork 24, a front wheel 26, a steering bar 36, and a seat 64 with a seat post 66, a rear frame 42, a pair of rear wheels 40L, 40R, a battery 52, a controller 54, and a throttle 38. The front frame 12 comprises a head tube 14, a top tube 16, a down tube 18, a seat tube 20, and a bottom tube 22. The front wheel consists of a tire 30, a rim 28, multiple spokes 32, and a hub motor 34. The hub motor 34 and throttle 38 are connected by wires 62, 60, and 58 to the controller 54 and the controller 54 is connected to the battery 52 with wire 56.

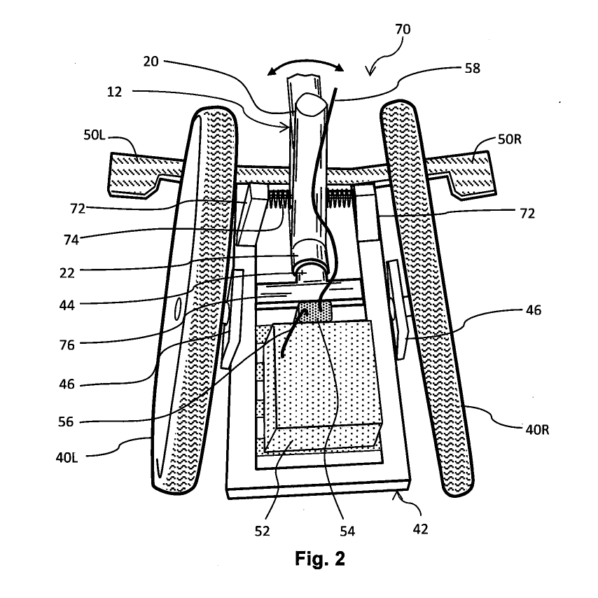

With reference to FIG. 2 for the prospective view 70 from the upper-rear of the first preferred embodiment 10, the rear frame 42 has two interconnected longitudinal bars to provide anchor plats 46 for the rear wheels 40L, 40R, footrests 50L, 50R at the front-left and front-right of the rear frame 42, and a shaft 44 to fit in the bottom tube 22 to rotatably connect the rear part of the tricycle with the front part of the tricycle. The rear frame 42 also has two vertical bars 72 and two compression springs 74 to hold the front frame 12 at a vertical position. The rear frame 42 also provides support to the battery 52 and the controller 54.

With reference to FIGS. 1 and 2 for the preferred embodiment 10, the bottom tube 22 and the shaft 44 are oriented along an axis line which points to the ground contact area of the front wheel 26, and therefore the front part of the tricycle can be tilted left or right freely to adjust gravity center while the two feet of the rider step on the footrests 501, 50R of the rear frame 42. As the shaft 44 is oriented along the axis line which points to the ground contact location of the front wheel, the tilting of the front part of the tricycle does not affect the position of the rear part.

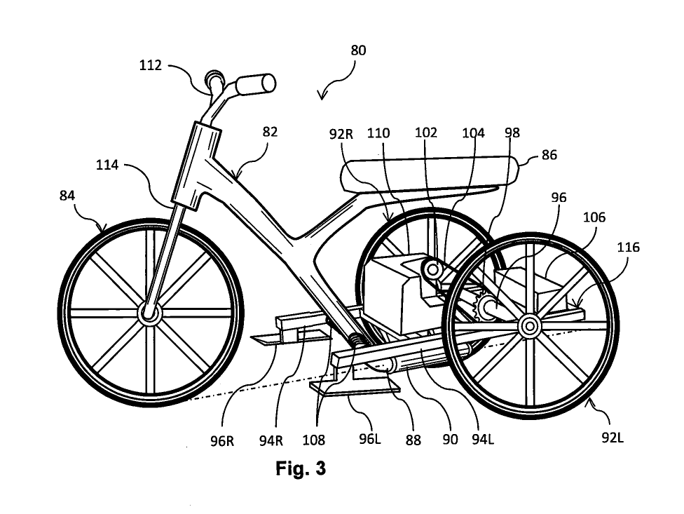

With reference to FIG. 3 for the second preferred embodiment 80, the present invention comprises a front part which further comprises a front frame 82, a front fork 114, a front wheel 84, a steering bar 112, and a seat 86, and a rear part which further comprises a rear frame 116, and two laterally spaced rear wheels 92L, 92R. The front frame 82 has a shaft 88 at the rear bottom, and the rear frame 116 has a tube 90 with bearings. The shaft 88 fits into the tube 90 to connect the front part and the rear part of the tricycle rotatably. The tricycle further comprises a motor 110 positioned on the rear frame 116 and engages with a freewheel 98 on a common axle 96 of the two rear wheels 92L, 92R through a chain 104 connecting the roller 102 of the motor 110 and the freewheel 98. The tricycle further comprises a power source 106 positioned on the rear frame 116 to supply power to the motor 110.

With reference to FIG. 3 for the second preferred embodiment 80, the present invention further comprise a mechanism to keep the front part at a upright vertical position and the mechanism consists of two compression springs 108 filled between the spaces between the front frame 82 and a left beam 94L of the rear frame 116 and between the front frame 82 and a right beam 94R of the rear frame 116. The rear frame 116 further has two footrests 96L, 96R extended from the left beam 94L and the right beam 94R of the rear frame 116.

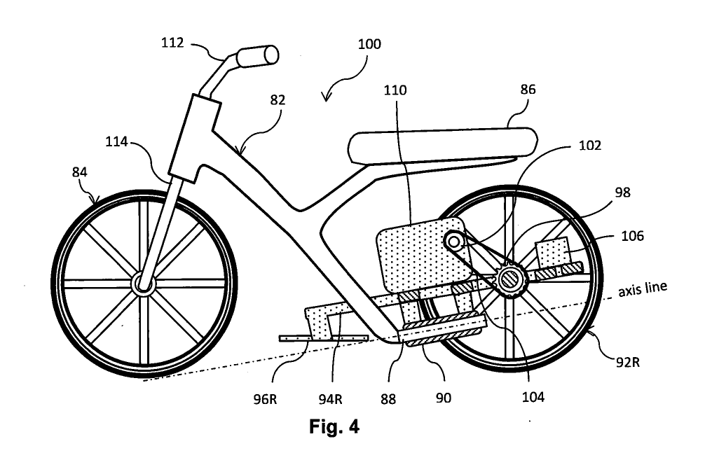

With reference to FIG. 4 for an vertical plane view 100 along a longitudinal line from left side of the second embodiment 80, the shaft 88 of the front frame 82 is rotatably connected with the bearing containing tube 90 and is oriented along an axis line which points to a ground contact spot of the front wheel 84 and this enables the front part of the tricycle to tilt right or left without affecting the position of the rear part.

The two preferred embodiments described above are for illustration purposes only to show the tilting mechanism of the present invention. The present invention can have a variety of additional embodiments such as different locations and types of the motor and the power source as well as different structures of frames and wheels without deviating from the basic tilting mechanism, which is to have a front part and a rear part and they are rotatably connected along an axis line which pointing to the ground contacting area of the front wheel, and the rear part has two footrests on two sides of the tricycle, and a user rides on the tricycle with two feet on the footrests and tilts the front part of the tricycle around the axis line to achieving tilting.

1. A tiltable motor tricycle comprises:
a) a front part comprising a front frame, a front fork mounted to the front frame, a front wheel mounted to the front fork, a seat, and a steering handle bar;
b) a rear part comprising a rear frame, a pair of laterally spaced rear wheels mounted to the rear frame;
c) the front frame and the rear frame have a tube and a shaft, and the tube is fitted over the shaft to form an integrated connection between the front frame and the rear frame and the front frame can swing from side to side relative to the rear frame;
d) a motor and a power source;

2. The tiltable motor tricycle of claim 1, wherein the tube for connection between the front frame and the rear frame is oriented along an axis line extending from the ground contact point of the front wheel upwardly and rear-wardly toward the center of the axle of the rear wheels, and rear frame has a pair of footrests on two sides of the tricycle;

3. The tiltable motor tricycle as in claim 1, wherein the motor is an electric hub motor mounted to the front wheel and the power source is a battery;

4. The tiltable motor tricycle as in claim 3 further comprises a throttle on the steering bar, and a controller; the controller is connected to the battery, the hub motor, and the throttle; and the throttle controls the power supply to the motor through the controller to turn on/off and adjust speed of the motor;

5. The tiltable motor tricycle as in claim 1, wherein the motor mounted to the rear frame to drive the rear wheels;

6. The tiltable motor tricycle as in claim 1, wherein the rear frame has a mechanism of exerting a pressure force from two sides to keep the front frame to a upright position and the mechanism consists of two compression springs from the sides of the rear frame to press on the front frame;

7. A tiltable motor tricycle comprises a front part and a rear part, and the front part further comprises a front frame, a front wheel and a steering bar, and a seat, and the rear part further comprises a rear frame and a pair of laterally spaced rear wheels mounted to the rear frame, and the front part and the rear part have a tube and a shaft and the tube and the shaft are coupled rotatably by fitting the tube over the shaft, and the connecting tube is positioned along an axis line from the ground contact area of the front wheel extending upwardly and rear-wardly toward the center between the two rear wheels; the tricycle further comprises a hub motor and a battery as a power source.
